(19) United States
(12) Patent Application Publication
(10) Pub. No.: US 2022/0401965 A1
(43) Pub. Date: Dec. 22, 2022

(54) INLET REGION OF A CENTRIFUGE SCREW, AND SOLID BOWL CENTRIFUGE

(71) Applicant: FLOTTWEG SE, Vilsbiburg (DE)

(72) Inventors: Georg Bauer, Geisenhausen (DE); Thomas Hasenecker, Eberspoint (DE); Lothar Fränkel, Gerzen (DE)

(21) Appl. No.: 17/776,461

(22) PCT Filed: Dec. 17, 2020
(86) PCT No.: PCT/EP2020/086617

§ 371 Date: May 12, 2022

(30) Foreign Application Priority Data
Dec. 19, 2019 (DE) 102019135226.6

(51) Int. Cl. B04B 1/20

(52) U.S. Cl. CPC B04B 1/20; B04B 2001/2033

(57) ABSTRACT

The invention relates to: an inlet region (80) of a centrifuge screw (30), the centrifuge screw (30) having, at least in the inlet region (80), a screw hub (32) with an open wall structure, in particular with longitudinal bars (58); and an inlet tube opening (47) of an inlet tube (46), the inlet tube opening (47) opening into the inlet region (80). Opposite the inlet tube opening (47) there is an impact element (70), in particular an impact disc, having an acceleration element (75), the acceleration element (75) being designed such that a medium impinging on the acceleration element (75) can be accelerated in the direction of open spaces (85) of the open wall structure, said open spaces being in particular between the longitudinal bars (58).

### DESCRIPTION

The invention relates to an inlet region of a centrifuge screw, the centrifuge screw having, at least in the inlet region, a screw hub with an open wall structure, in particular with longitudinal bars, according to the feature combination of claim 1. Furthermore, the invention relates to a solid bowl screw centrifuge comprising a centrifuge screw located within a drum, the centrifuge screw having, at least in the inlet region, a screw hub with an open wall structure, in particular with longitudinal bars and/or being formed of longitudinal bars, according to claim 11.

Solid bowl screw centrifuges are characterized by a drum having a closed or solid bowl. The drum is rotated at high rotational speed allowing a multiphase mixture located within the drum to be at least separated into a heavy phase and a light phase. Usually, the heavy phase is a solid phase conveyed out from the drum by means of a screw, i.e., a centrifuge screw. For this purpose, the screw is mounted within the drum to be rotational in relation to the drum and has a screw spiral coil. The screw spiral coil is arranged around a screw hub.

The screw spiral coil strikes along the inner side or the inner bowl surface of the drum and thus conveys the product of the heavy phase to an axial end region of the drum. At the end of the drum, the product of the heavy phase is conveyed out from a discharge cone, for example. The multiphase mixture to be clarified thus is located between the inner side of the drum and the screw hub.

In certain solid bowl screw centrifuges, a large pond depth is aspired, in particular for clarification technological reasons. At the same time, however, the pond depth is restricted by the diameter of the screw hub and there resulting buoyancy and deposition effects of the mixture to be clarified or the light phase.

From the state of the art, it is moreover known that the mixture to be clarified gets into an inlet chamber via an inlet tube. This inlet chamber usually is a section of a screw hub interior. In the massive screw hub, openings are formed for this reason, so that the mixture to be clarified gets into the drum interior or into the separation space through the openings. Under certain circumstances, this causes disadvantageous turbulences within the inlet chamber, wherein the product to be clarified or the medium is already separated partially within the inlet chamber.

Based on the mentioned state of the art, the task of the present invention is to propose a further developed inlet region of a centrifuge screw allowing, on the one hand, large pond depth, and, on the other hand, causing the medium to be conveyed rapidly.

Furthermore, it is the task of the present invention to propose a further developed solid bowl screw centrifuge which is in particular further developed with regard to the inlet region.

This task is solved with respect to the inlet region by the subject matter of claim 1, and with respect to the solid bowl screw centrifuge by the subject matter of claim 13. The subclaims comprise at least appropriate configurations and further developments.

According to the invention, an inlet region of a centrifuge screw is taken as a basis, the centrifuge screw having at least one screw hub with an open wall structure, in particular with longitudinal bars. An inlet tube having an inlet tube opening opens into the inlet region, wherein opposite the inlet tube opening, an impact element is formed, in particular an impact disc, having an acceleration element. The acceleration element is designed such that a medium impinging on the acceleration element can be accelerated in the direction of free spaces of the wall structure, said free spaces being in particular formed between the longitudinal bars.

As an open wall structure, in particular such a wall structure is to be understood which has a material fraction as low as possible. In other words, an open wall structure has a portion of free or open spaces that is as high as possible.

The open wall structure may in particular be formed by means of a grid structure. In a preferred embodiment of the invention, the grid structure is formed of several longitudinal bars.

It is furthermore possible to design the wall structure with a plurality of longitudinal bars.

Since the screw hub according to the invention is formed at least in sections of an open wall structure, in particular of longitudinal bars, or has longitudinal bars, a large pond depth can be created in an associated solid bowl screw centrifuge. Since the inlet region is not designed in the classical sense as an inlet chamber having corresponding massive and mostly closed walls, but is rather formed itself, for example, by the longitudinal bars of a screw hub, the free spaces, in particular formed between the longitudinal bars, can serve as openings themselves.

In other words, the inlet region according to the invention preferably is not designed as an inlet chamber having massive and mostly closed walls.

Preferably, no further medium directing installations are formed in the region between the inlet tube opening and the acceleration element. Medium directing installations, for example, may be conical chamber sections which would direct a product beam in the direction of the impact element and in the direction of the acceleration element. Such installations are preferably renounced of in conjunction with the inlet region according to the invention.

In a preferred embodiment of the invention, no further installations are formed in the region between the inlet tube opening and the acceleration element.

It is possible for single sections of the screw hub, such as, e.g., transverse struts to be formed in the region between the inlet tube opening and the acceleration element. These, however, are not further installations of the inlet region, but components of the screw hub.

The inlet region should substantially be created of as few components as possible. This has corresponding advantages with regard to the weights involved in the inlet region and the masses to be accelerated.

Preferably, at least in the region of the inlet chamber, the screw hub is completely created of longitudinal bars. In this embodiment, these free spaces constitute the free spaces of the wall structure of the screw hub. In other embodiments of the invention, for example, the free spaces may be created by longitudinal slots formed within the wall. Other shapes of formed free spaces are also possible.

In other words, the inlet region of a centrifuge screw comprises, at least in sections, an inlet tube, wherein at least the section of the inlet tube having an inlet tube opening is formed as a component of the inlet region of the centrifuge screw.

Preferably, the inlet region is defined to be such a region of the centrifuge screw, which starts in the longitudinal extension of the centrifuge screw with the inlet tube opening and ends at the impact element. In other words, the inlet region of a centrifuge screw extends in a longitudinal extension of a vertical of the inlet tube opening up to the impact element, in particular up to the impact disc. The vertical of the inlet tube element runs vertically to the longitudinal axis of the centrifuge screw. The inlet region is related preferably to the complete space within the screw hub in the mentioned longitudinal extension.

The impact element is preferably designed as an impact disc. Such an impact disc may also be designated a closing disc. Due to the acceleration element formed on the impact element, pre-acceleration of the medium to be processed can take place.

The impact disc may be in particular a transverse disc of the screw hub. In such an embodiment of the invention, an already existing transverse disc of a solid bowl screw centrifuge or a screw hub of a centrifuge screw would have an additional function, namely the function of an impact disc. In such a case, it is possible for the acceleration element of the inlet region to be directly arranged or formed on a transverse disc of the screw hub.

The acceleration element has impact surfaces preferably placed transversely to the axis of rotation. Due to the acceleration element being formed, the medium impinging on the impact element or the acceleration element may be pre-accelerated relatively free from turbulences in a careful manner.

The surrounding geometry with an open wall structure, in particular with longitudinal bars, and an open liquid surface may anyway receive the medium in the longitudinal and circumferential direction more carefully than a tube construction with inlet openings. With the acceleration element being inserted, the difference of velocity, however, is reduced again in a positive manner when the medium impinges.

The acceleration takes place in the direction of the free spaces of the wall structure, which free spaces are in particular formed between the longitudinal bars. Only then the medium enters into the drum interior or the separating space through the free spaces when the screw hub is rotating.

Occurring turbulences known from the state of the art and associated with the medium flow flowing into an inlet chamber and subsequently getting into the drum interior, may be attenuated and energy losses be reduced according to the invention.

The massive walls known from inlet chambers formed in a standard way are omitted in the inlet region according to the invention and rather are formed by longitudinal bars, for example. The longitudinal bars are substantially arranged in parallel to the longitudinal axis of the centrifuge screw. Preferably, all of the longitudinal bars are on a concentric circle line to the longitudinal axis.

The free spaces are in particular created by the distance between the longitudinal bars. Apart from the improved pre-acceleration of the medium to be processed, the inlet region according to the invention promotes additives to be better mixed in. These additives may be, for example, precipitants or flocculants.

The size or the entry surface of the free spaces preferably is determined based on the distances formed between the longitudinal bars. In a further embodiment of the invention, the size or the entry surface of the free spaces is created by the size and the shape of longitudinal slots of the screw hub.

The acceleration element substantially is formed as a protrusion pointing in the direction of the inlet tube opening. It is possible for the protrusion to be arranged on a disc or plate. The disc or plate may be formed to be planar or convex.

The protrusion may form an autonomous component together with the disc or plate, which can be manufactured separately from the impact element, in particular the impact disc. This facilitates, for example, retrofitting of an impact element with the acceleration element.

In a further embodiment of the invention, it is possible for the protrusion to be attached directly to the impact element, in particular the impact disc. This enables material to be saved.

In an embodiment of the invention, the acceleration element has struts, which are in particular arranged in a cross-shape to one another. It is also conceivable for several struts to constitute a star-shape in a top view upon the acceleration element. In such an embodiment of the invention, the protrusion is formed by an arrangement of struts.

In an embodiment of the invention, it is possible for the height of the struts to increase in the direction of a point of intersection of the struts. The height of the struts is understood to be the relative distance from the impact element, in particular the impact disc, or—if formed—the relative distance from the separate disc or plate.

Preferably, the acceleration element is arranged on the impact element such that a point of intersection and/or a highest position of the acceleration element are/is formed to be aligned with the central point of the impact element, in particular the impact disc. In other words, the point of intersection and/or the highest point of the impact element are/is arranged on the longitudinal axis of the centrifuge screw.

In a further or alternative embodiment of the invention, the acceleration element may be formed to be a protrusion protruding from the impact element and pointing in the direction of the inlet opening. This protrusion has several radial flanks. Radial flanks are to be understood to be such flanks running in the direction of the impact element starting from a centrally arranged central point. Preferably, the radial flanks are arranged uniformly or evenly spaced from one another in the circumferential direction.

It is furthermore possible for channels to be formed between the flanks, wherein the channels can have a swirling course. If a medium impinges upon such an acceleration element, the medium will be deviated and accelerated along the channels in the direction of the impact element and in the direction of the free spaces. In other words, the channels and/or flanks are evenly distributed across the protrusion.

It is possible for the acceleration element to be formed as a protrusion protruding from the impact element and pointing in the direction of the inlet opening, and which has several, for example four, impact surfaces arranged obliquely to the longitudinal axis of the inlet region. The longitudinal axis of the inlet region is in particular the axis of rotation of the centrifuge screw.

The impact surfaces may be arranged to one another, for example, in such a manner that the protrusion has a pyramid shape. The pyramid tip may in particular be formed to be flattened.

In a further embodiment of the invention, several oblique struts stabilizing the screw hub are attached to the impact element, in particular the impact disc. An end of the stabilizing oblique struts may be formed on the impact element. The further end may be attached, for example, to a further transverse disc of the centrifuge screw or to an end disc of a centrifuge screw.

These stabilizing oblique struts preferably are constructed and formed such that a product exiting from the inlet tube opening is at least not substantially influenced by the oblique struts when covering the path in the direction of the impact element or in the direction of the acceleration element. The oblique struts preferably have such a swirling course that the product exiting from the inlet tube opening does not or at least not substantially get into contact with the oblique struts.

A further aspect of the invention relates to a solid bowl screw centrifuge comprising a centrifuge screw located within a drum, the centrifuge screw having, at least in the inlet region, a screw hub with an open wall structure, in particular with longitudinal bars and/or is formed of longitudinal bars. The inlet region is formed according to the invention.

In a further embodiment of the invention, the screw hub is created in several sections of longitudinal bars or has longitudinal bars in several sections. In other words, the screw hub is not created of longitudinal bars only in the inlet region or does not have longitudinal bars only in the inlet region. Preferably, the screw hub is created completely by longitudinal bars in a cylindrical longitudinal section.

It should be pointed out that, in the spirit of the invention, the screw hub can also have oblique struts and transverse discs in addition to the longitudinal bars. The oblique struts and the transverse discs serve for additionally stabilizing the screw hub construction. In a further embodiment of the invention, it is possible for the screw hub to have longitudinal bars across the entire longitudinal extension.

The screw hub is thus configured of a grid structure at least in sections. This grid structure is basically not closed to the outside, but open, and consequently can plunge into the pond of the mixture to be clarified circulating within the drum without problems occurring by buoyancy forces.

In an embodiment of the invention, the inlet region can be variably positioned. Variably positioning the inlet region has the advantage that the position of the acceleration element and thus the position of inletting a medium into the drum of the solid bowl screw centrifuge can be adapted in dependence of the medium to be processed. It is possible for various media to find and to realize a specific and optimum inlet position into the drum starting from the screw hub.

A variable position of the inlet region is in particular adjustable by positioning an impact disc and by selecting the length of the inlet tube. The position of the impact element, in particular of the impact disc, may be variably positioned starting from a first front side in the direction of a solid discharge side section. With a corresponding displacement of the impact element, in particular of the impact disc, in the direction of the solid discharge side section of the solid bowl screw centrifuge, the length of the inlet pipe also increases. Preferably, the longitudinal extension of the inlet region is approximately identical independent of the respective position, even when the impact element, in particular the impact disc, is variably positioned. Thus, it is necessary for the length of the inlet tube to be adapted correspondingly, i.e., extended or shortened, when the impact element, in particular the impact disc is positioned correspondingly, so that the distance between the inlet tube opening and the impact element, in particular the impact disc, does neither exceed nor fall below an optimum value.

The distance between the inlet tube opening and the impact element, in particular the impact disc, preferably corresponds to the longitudinal extension of the inlet region.

The longitudinal extension of the inlet region is at most 50% of the total length of the centrifuge screw, in particular at most 33% of the total length of the centrifuge screw, in particular at most 25% of the total length of the centrifuge screw.

In the longitudinal direction of a solid bowl screw centrifuge, the impact element, in particular the impact disc, of the inlet region may be arranged within an impact element arrangement region.

The longitudinal direction of the solid bowl screw centrifuge is defined starting from a first front surface of the drum in the direction of a second front surface of the drum, wherein the second front surface of the drum is assigned to the solid discharge side section of the solid bowl screw centrifuge.

The impact element arrangement region extends in an area starting at a fifth of the total length of the centrifuge screw up to a transition between a cylindrical longitudinal section of the centrifuge screw to a conical longitudinal section of the centrifuge screw.

Especially preferred, the impact element, in particular the impact disc, is arranged in such an impact element arrangement region in relation to a central area with respect to the total length of the centrifuge screw. This central area preferably extends more in the direction of a conical longitudinal section than in the direction of a first front side of a drum of the solid bowl screw centrifuge.

Due to the configuration of the screw hub by means of a grid structure, it can be achieved that sedimented particles sinking from the mixture to be clarified in the direction of the inner side of the drum will not remain adhered to the grid structure. Such particles rather will slide from the grid structure having the longitudinal bars radially to the outside or into the outer area of the drum.

It is possible for a conical longitudinal section of the screw hub to have longitudinal bars as well. In other words, the conical longitudinal section of the screw hub may likewise be created of a grid structure.

In the open wall structure, in particular between the longitudinal bars, of the inlet region of the centrifuge screw, free spaces are formed constituting the outflow openings in the direction of a separating space. The separating space is created between the screw hub and a drum shell or the inner side of the drum.

At adjacent transverse discs of the screw hub, oblique struts are advantageously formed. Preferably, three oblique struts in total are arranged spaced across the circumference of the screw hub in an evenly distributed manner.

The same advantages are the result in conjunction with the solid bowl screw centrifuge according to the invention as are achieved in conjunction with the inlet region according to the invention.

The solid bowl screw centrifuge according to the invention may be both a 2-phase solid bowl screw centrifuge and a 3-phase solid bowl screw centrifuge.

On the one hand, it is possible for a large pond depth to be formed within the solid bowl screw centrifuge. At the same time, the medium flowing into the inlet region of the centrifuge screw can get into the drum interior or the separating space in a pre-accelerated manner so that clarification technological improvements and a faster transportation of the medium are enabled in this respect.

Hereinafter, exemplary embodiments of the solution according to the invention will be explained in more detail on the basis of appended schematical drawings.

Shown are in:

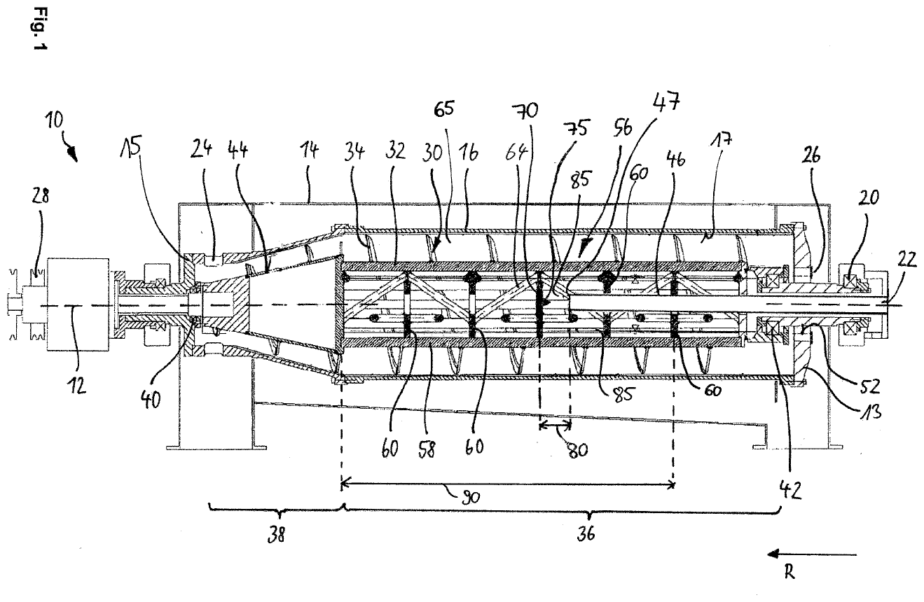

FIG. 1 a longitudinal cut of the solid bowl screw centrifuge according to the invention, which has an inlet region according to the invention;

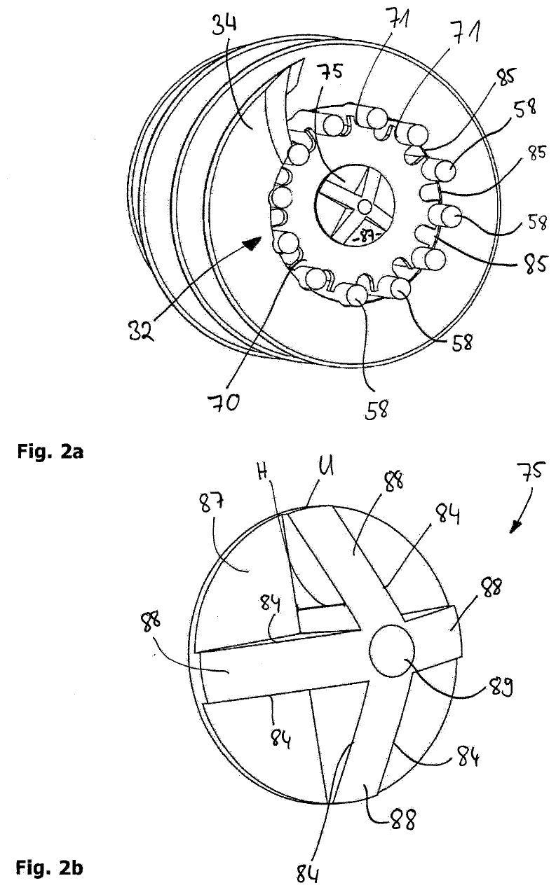

FIGS. 2a and 2b a first embodiment of an acceleration element;

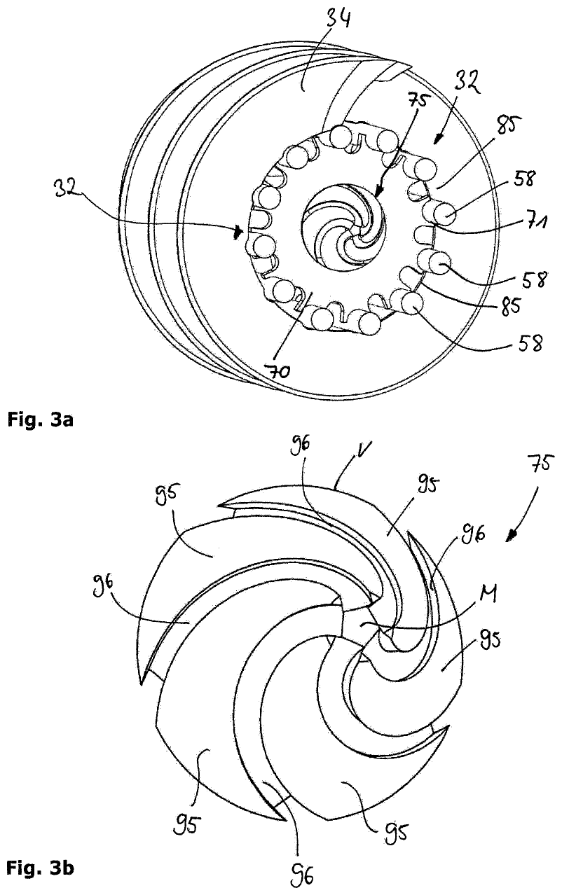

FIGS. 3a and 3b a representation of a further embodiment according to the invention of an acceleration element; and

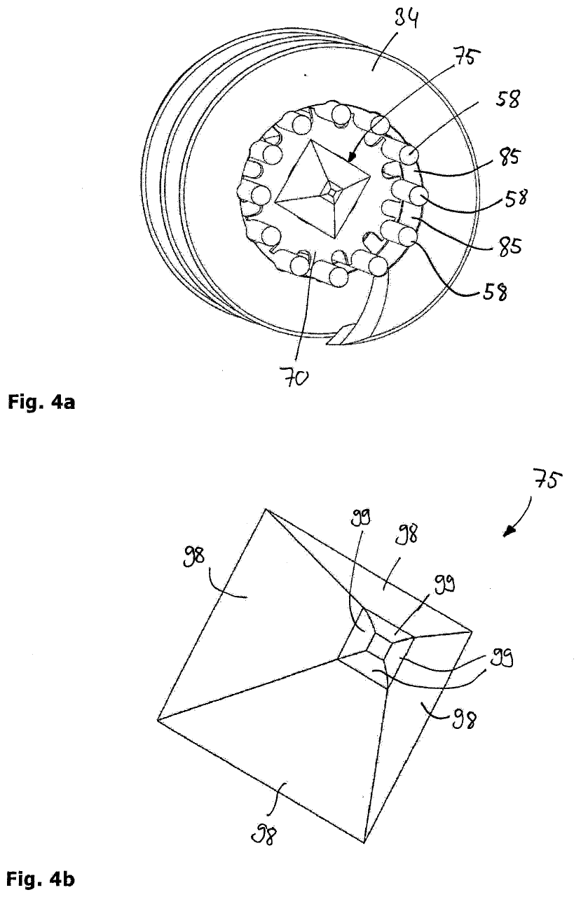

FIGS. 4a and 4b a representation of a further embodiment according to the invention of an acceleration element.

In the following, the same reference numerals will be used for identical parts or parts of identical action.

In FIG. 1, a solid bowl screw centrifuge 10 is represented, which extends substantially along a horizontal longitudinal axis 12. The solid bowl screw centrifuge 10 has an outer housing 14, in which a drum 16 is mounted to be rotational about the longitudinal axis 12. By rotating the drum 16 at high rotational speed, a centrifugal force can be generated within it, by means of which a product to be clarified can be separated into a heavy phase and a light phase. For this purpose, the drum 16 is supported on a first drum bearing 18 and a second drum bearing 20. The represented solid bowl screw centrifuge 10 is a 2-phase solid bowl screw centrifuge. The inlet region according to the invention can be realized, however, in a 3-phase solid bowl screw centrifuge as well.

At the drum 16, an inlet 22 for the product to be clarified and an outlet 24 for the heavy phase and an outlet 26 for the light phase are formed. For rotating the drum 16, a drive 28 is formed.

The outlet 26 acts as an overflow for the light phase located radially inside the drum 16, so that the light phase exits there autonomously, if a predetermined level, the so-called pond depth 52, is reached within the drum.

At the drum 16, two front sides, namely a first front side 13 and a second front side 15 are moreover formed. The first front side 13 is in this case assigned to the area of the outlet 26 for the light phase. The second front side 15 in turn is assigned to the area of the outlet 24 for the heavy phase.

Furthermore, the longitudinal direction R is represented. The longitudinal direction R substantially runs in parallel to the longitudinal axis 12. The longitudinal direction R is defined in the represented example as the direction of transportation of the solid discharge. Accordingly, the first front side 13 is the first front side of the drum 16 in the longitudinal direction R. The second front side 15 is the second front side of the drum 16 in the longitudinal direction R.

So that the heavy phase located radially outside within the drum can be discharged from the drum 16, a centrifuge screw 30 is provided within the drum 16. The centrifuge screw 30 is rotated relative to the drum 16 by means of the drive 28. Thereby, the material of the heavy phase is discharged to radially inside and thus to the outlet 24 along a cone formed at the drum 16.

For this purpose, the centrifuge screw 30 is configured with a screw hub 32 extending longitudinally to the longitudinal axis 12, which screw hub is surrounded radially outside by a screw spiral coil 34. The screw hub 32 consequently serves the purpose of supporting the screw spiral coil 34 in the radial direction, of transmitting torque from the drive 28 to the screw spiral coil 34, and of receiving in particular tensile forces and thrust forces in this case. The screw hub 32 is configured by a grid structure 56 in the cylindrical longitudinal section 36.

The grid structure 56 has twelve longitudinal bars 58, which are arranged to be distributed at uniform distances across the circumference of the screw hub 32 in the longitudinal direction thereof, thus in parallel to the longitudinal axis 12. In the represented exemplary embodiment, the open wall structure thus is created due to the longitudinal bars 58. Alternative embodiments for constituting an open wall structure are possible. By way of example, an open wall structure may be created by forming a plurality of longitudinal slots in the screw hub 32.

The preferred number of longitudinal bars 58 is between 8 and 16, in particular between 10 and 14. Radially outside, the longitudinal bars 58 each constitute a contact surface for the screw spiral coil 34 and are supported radially inside on transverse discs 60. The longitudinal bars 58 extend in this case beyond the transverse discs 60, which are oriented transversely to the longitudinal axis 12 and thus form an inner support for the longitudinal bars 58.

Between two and six oblique struts 64 extend between each of two transverse discs 60. Particularly preferred, three oblique struts 64 are formed.

Within the conical longitudinal section 38, a screw hub 32 having a shell surface 44 is formed. The shell surface 44 is substantially closed and in particular configured by means of a sheet metal or a tube surface. The centrifuge screw 30 is mounted to be rotatable by means of a first screw bearing 40 and a second screw bearing 42.

In FIG. 1, an inlet tube 46 can be recognized furthermore. Through this inlet tube 46, the medium to be separated gets into the solid bowl screw centrifuge 10. The inlet tube 46 has an inlet tube opening 47.

The inlet tube 46 serves the purpose of supplying the product to be clarified centrally in the inlet region 80 and into the interior of the screw hub 32. The inlet region 80 in FIG. 1 is to be understood as being that section, which is represented between the two dashed lines. The inlet region is delimited in one direction by the inlet tube opening 47. Opposite the inlet tube opening 47, an impact element 70 is formed. In other words, the inlet region 80 of the screw hub 32 extends at least from the inlet tube opening 47 up to the impact element 70.

The impact element 70 is formed in the present case as an impact disc. On the impact element 70, an acceleration element 75 is formed. The acceleration element 75 is substantially formed as a protrusion pointing from the impact element 70 in the direction of the inlet tube opening 47.

It can be recognized that the inlet region 80 is defined as such an area, which is formed between the inlet tube opening 47 and the impact element 70. In other words, the inlet region 80 is the area, which is formed due to the distance between the inlet tube opening 47 and the impact element 70. In this case, not only the perpendicular between the inlet tube opening 47 and the impact element 70, as can be recognized by the dashed representation, is to be understood as the inlet region 80, but also the complete radial space within the screw hub 32 having an extension in the longitudinal direction R, which corresponds to the distance between the inlet tube opening 47 and the impact element 70. In other words, the inlet region 80 may concern a cylindrical space.

In other words, the described distance between the inlet tube opening 47 and the impact element 70 corresponds to the longitudinal extension in the longitudinal direction of the inlet region 80. Preferably, the longitudinal extension of the inlet region 80 is at maximum 50% of the total length of the cylindrical longitudinal section 36.

The inlet region 80 in the represented example is formed to be approximately central in the cylindrical longitudinal section 36. In particular the impact element 70, in particular the impact disc, is formed in a central section of the cylindrical longitudinal section 36. The position of the inlet region 80, in particular the position of the impact element 70, may be formed in an impact element arrangement region 90. The maximum position of the impact element 70 is in this case formed in the transition area from the cylindrical longitudinal section 36 to the conical longitudinal section 38. In this case, the impact element 70 is formed as an end disc of the cylindrical longitudinal section 36. Furthermore, it is conceivable for the impact element 70 to be formed at the shown positions of the transverse discs 60. The first transverse disc 60 in the longitudinal direction R preferably is located at a position having a distance to the beginning of the screw 30, which corresponds at maximum to a third, at maximum to a fourth, at maximum to a fifth of the total length of the centrifuge screw 30.

Due to positioning of the impact element 70 and by correspondingly selecting the length of the inlet tube 46, the position of the inlet region 80 can be variably designed. The variable design of the position of the inlet region 80 basically is advantageous, since with the help of a variable position of the inlet region 80, an optimum inlet position for various media as well as for various throughputs can be realized in each case.

The acceleration element 75 is formed such that a medium impinging on the acceleration element 75 or the product to be clarified can be accelerated in the direction of free spaces 85 of the open wall structure. In the represented example, the free spaces 85 are formed between the longitudinal bars 58 of the screw hub 32. The free spaces 85 are created due to the distance formed in each case between the longitudinal bars 58. The free spaces 85 serve as outflow openings for the medium.

The product to be separated or the medium gets into the drum interior 65, which may also be referred to as a separating space, via the free spaces 85. The space, which is created between the drum 16 or the drum inner surface 17 and the screw hub 32 may be referred to as the drum interior 65. The size of the available openings, through which the medium can get from the inlet region 80 into the drum interior 65, is defined based on the size of the free spaces 85 and thus based on the distance formed between the longitudinal bars 58. These explanations apply in conjunction with all of the represented embodiments of the inlet region 80 or the acceleration element 75 according to the invention.

The acceleration element 75 causes the medium to be pre-accelerated and additives to be better mixed in.

In FIGS. 2a and 2b, FIGS. 3a and 3b, as well as FIGS. 4a and 4b, three different embodiments of acceleration elements are represented.

FIG. 2a shows a top view of an impact element 70. For better representability of the impact element and the acceleration element 75, further components of the screw hub 32 are not represented completely in the top view.

It can be recognized that the screw hub 32 is formed inter alia by longitudinal bars 58. In the present case, twelve longitudinal bars 58 are formed. The impact element 70 inter alia serves for stabilizing the screw hub 32. For this purpose, the impact element 70 has recesses 71 into which the longitudinal bars 58 are inserted.

Furthermore, a screw spiral coil 34 is represented schematically. This spiral coil extends helicoidally in the longitudinal extension of the longitudinal bars 58. The impact element 70, which may be referred to as an impact disc, has the acceleration element 75.

As can be recognized in FIG. 2b, the acceleration element 75 has four struts 88 arranged in a cross-shape to one another. The point of intersection 89 constitutes at the same time the point of the acceleration element 75 having the largest height in relation to the impact element 70. Furthermore, it can be recognized that the heights H of the struts 88 increase in the direction of the point of intersection 89. The struts 88 themselves are arranged on a disc 87. Accordingly, it is possible for the acceleration element 75 to be first produced as an intermediate element or an autonomous assembly.

In other words, the height H of the struts 88 respectively increases starting from the circumference U of the disc 87 in the direction of the point of intersection 89.

In a further embodiment of the invention (not represented) additional struts may be arranged so that these struts 88 can constitute a star-shape. It is moreover possible for the struts 88 to have no edges 84 and to be formed rounded. An arcuate course of the struts 88 is also possible.

The free spaces 85 are formed between the longitudinal bars 58. The free spaces 85 thus constitute the outflow openings for the medium or the product to be clarified.

The point of intersection 89 of the acceleration element 75 is in particular formed on the longitudinal axis 12 of the solid bowl screw centrifuge.

In addition, oblique struts 64 (not represented) may be attached to the impact element 70. This serves in particular for stabilizing the screw hub 32.

A further embodiment of a potential inlet region 80 is at least in part represented in FIG. 3a. In the following, only the difference from the embodiment according to FIGS. 2a and 2b will be discussed. Accordingly, the acceleration element 75 directly arranged on the impact element 70 is formed differently.

In FIG. 3b, this is represented more clearly. The acceleration element 75 is formed as a protrusion protruding from the impact element 70. Several radial flanks 95 can be recognized. Between the flanks 95, channels 96 are created.

Both the flanks 95 and the channels 96 have a swirling course. Starting from the central point M of the acceleration element 75, the flanks 95 and thus the channels 96 formed between the flanks 95 run in a swirling manner in the direction of the circumference V. If a medium to be clarified impinges on the central point M of the acceleration element 75, pre-acceleration of the medium or the product to be clarified can take place due to the channels being formed in a swirling manner.

A further embodiment of a potential inlet region 80 is at least in part represented in FIG. 4a. In the following, only the difference from the embodiment according to FIGS. 2a and 2b will be discussed. Accordingly, the acceleration element 75 directly arranged on the impact element 70 is formed differently.

In FIG. 4b, this is represented more clearly. The acceleration element 75 is formed as a protrusion protruding from the impact element 70. The protrusion has several impact surfaces 98 arranged obliquely to the longitudinal extension of the inlet region 80. The impact surfaces 98 are arranged to one another in such a manner that a pyramidal protrusion shape is created. The protrusion, however, does not have a tip. The impact surfaces 98 rather have flattening segments 99 respectively.

### LIST OF REFERENCE NUMERALS

10 solid bowl screw centrifuge

12 longitudinal axis

13 first front side

14 outer housing

15 second front side

16 drum

17 drum inner surface

18 first drum bearing

20 second drum bearing

22 inlet for the product to be clarified/medium

24 outlet for the heavy phase

26 outlet for the light phase

28 drive

30 centrifuge screw

32 screw hub

34 screw spiral coil

36 cylindrical longitudinal section

38 conical longitudinal section

40 first screw bearing

42 second screw bearing

44 closed shell surface

46 inlet tube

47 inlet tube opening

52 pond depth

56 grid structure

58 longitudinal bar

60 transverse disc

64 oblique disc

65 drum interior/separating space

70 impact element

71 recess

75 acceleration element

80 inlet region

84 edge

85 free space

87 disc

88 strut

89 point of intersection

90 impact element arrangement region

95 flank

96 channel

98 impact surface

99 flattening segments

H height of strut

M central point

R longitudinal direction

U circumference of disc

V circumference of acceleration element

1. An inlet region (80) of a centrifuge screw (3), the centrifuge screw (30) having, at least in the inlet region (80), a screw hub (32) with an open wall structure, in particular with longitudinal bars (58), wherein an inlet tube opening (47) of an inlet tube (46) opens into the inlet region (80), wherein opposite the inlet tube opening (47), there is formed an impact element (70), in particular an impact disc, having an acceleration element (75), wherein the acceleration element (75) is designed such that a medium impinging on the acceleration element (75) can be accelerated in the direction of free spaces (85) of the wall structure, said free spaces being in particular formed between the longitudinal bars (58).

2. The inlet region (80) according to claim 1,
characterized in that
the free spaces (85) constitute outflow openings for the medium.

3. The inlet region (80) according to claim 1,
characterized in that
the inlet region (80) is not designed as an inlet chamber having massive and mostly closed walls.

4. The inlet region (80) according to claim 1,
characterized in that
in the region between the inlet tube opening (47) and the acceleration element (75), no further medium directing installations are formed.

5. The inlet region (80) according to claim 1,
characterized in that
the acceleration element (75) has struts (88), which are in particular arranged in a cross-shape to one another.

6. The inlet region (80) according to claim 5,
characterized in that
the height (H) of the struts (88) increases in the direction of a point of intersection (89) of the struts (88).

7. The inlet region (80) according to claim 1,
characterized in that
the acceleration element (75) is formed as a protrusion protruding from the impact element (70) and pointing in the direction of the inlet tube opening (47), and which preferably has several radial flanks (95).

8. The inlet region (80) according to claim 7,
characterized in that
channels (96) are formed between the flanks (95), wherein the channels (96) have a swirling course.

9. The inlet region (80) according to claim 1,
characterized in that
the acceleration element (75) is formed as a protrusion protruding from the impact element (70) and pointing in the direction of the inlet tube opening (47), and which has several impact surfaces (98) arranged obliquely to the longitudinal extension of the inlet region (80).

10. The inlet region (80) according to claim 1,
characterized in that,
to the impact element (70), in particular to the impact disc, several oblique struts (64) are attached stabilizing the screw hub (32).

11. A solid bowl screw centrifuge (10) comprising a centrifuge screw (30) located within a drum (16), wherein the centrifuge screw (30), at least in the inlet region (80), comprises a screw hub (32) which has an open wall structure, in particular longitudinal bars (58) and/or is created of longitudinal bars (58),
characterized in that
the inlet region (80) is formed according to claim 1.

12. The solid bowl screw centrifuge (10) according to claim 11,
characterized in that
free spaces (85) are formed within the wall structure, in particular between the longitudinal bars (58), and constitute outflow openings in the direction of a drum interior (65) created between the screw hub (32) and a drum inner surface (17).

13. The solid bowl screw centrifuge (10) according to claim 11,
characterized in that
the inlet region (80) can be variably positioned.

14. The solid bowl screw centrifuge (10) according to claim 13,
characterized in that
the variable position of the inlet range (80) is adjustable by positioning the impact element (70) and by selecting the length of the inlet tube (46).

15. The solid bowl screw centrifuge (10) according to claim 11,
characterized in that
the longitudinal extension of the inlet range (80) is at most 50% of the total length of the centrifuge screw (30), in particular at most 33% of the total length of the centrifuge screw (30), in particular at most 25% of the total length of the centrifuge screw (30).
